(19) United States
(12) Patent Application Publication
(10) Pub. No.: US 2014/0024303 A1
(43) Pub. Date: Jan. 23, 2014

(54) AIR CONDITIONING SYSTEM FOR MOTOR VEHICLE

(71) Applicant: Visteon Global Technologies, Inc., Van Buren Twp., MI (US)

(72) Inventors: Johannes Stausberg, Koln (DE); Mario Opiela, Aachen (DE)

(73) Assignee: Visteon Global Technologies, Inc., Van Buren Twp., MI (US)

(21) Appl. No.: 13/946,116

(22) Filed: Jul. 19, 2013

(30) Foreign Application Priority Data
Jul. 20, 2012 (DE) 10 2012 106 619.1

(51) Int. Cl. B60H 1/24; B60H 1/34

(52) U.S. Cl. CPC B60H 1/241; B60H 1/34
USPC 454/152; 454/143

(57) ABSTRACT

The invention concerns an air-ducting transition element of an automotive air conditioner, which is characterized in that there is arranged inside the transition element a feedthrough for lines, wherein the feedthrough is a flow ducting element that divides the air flow through the transition element into at least two flow pathways.

### CROSS-REFERENCE TO RELATED APPLICATION

This application claims priority to German Non-Provisional Patent Application Serial No. DE 10 2012 106 619.1 filed Jul. 20, 2012, hereby incorporated herein by reference in its entirety.

### FIELD OF THE INVENTION

The invention concerns the air-ducting sections of an automotive air conditioner, which are arranged between the fan and the air distributing housing, These sections are either outfitted only with a diffuser or, alternatively, an arrangement of a diffuser, another area that can contain a filter, a heat exchanger, or both, and a connection piece,

### BACKGROUND OF THE INVENTION

Automotive air conditioners are usually arranged near the front wall of the passenger compartment, beneath the dashboard, which on account of the scant space available, especially in the area between glove compartment and front wall, and also between the center console and the front wall, demands optimization of the arrangement of the individual components and their connection lines.

The connection lines for the working fluids of the automotive air conditioner, such as the pipes for the coolant from the coolant circuit of the vehicle or the refrigerant lines from the refrigeration system or the heat pump, on account of the scant space available are partly laid in deep indentations in the housing walls of the air conditioner, especially in the diffuser, in order to take the lines up to the required and partly standardized fluid interface points.

The diffuser, quite generally, is a structural part that slows down the gas flows and increases the static gas pressure and thus in fluid dynamics theory constitutes the opposite of a nozzle. Diffusers are used to convert kinetic energy into pressure energy according to the Bernoulli equation. For this, the flow must be decelerated. One generally accomplishes this by continuous or discontinuous broadening of the flow cross section in the direction of flow, which can be realized geometrically in various ways. Quite often, for example, this is achieved by a conical shape. The invention concerns diffusers that are arranged in automotive air conditioners between the fan and another area of the air conditioner.

Diffusers for automotive air conditioners are known in the prior art. In Patent No. EP 1997656 B1, for example, a flow ducting element in a fluid channel of an automotive air conditioner is described, wherein at least one flow ducting element divides the fluid channel into two partial fluid channels. The fluid channel, besides the diffuser region, also has a nozzle region, in which the velocity of the flowing air is increased once more by bends and narrowing regions. In this way, the stated problem of homogenization of the velocity profile in the fluid channel and problems with sound absorption are solved.

The flow ducting element is arranged in the fluid channel as a multipart body, while the configuration of the contour of the flow ducting element primarily takes into account fluid dynamic and acoustic requirements.

In practice, it is necessary in automotive air conditioners to lead their fluid lines to the interfaces between their housings and the front wall of the passenger compartment. The designs in the prior art require deep indentations in the diffuser housing on account of limited space availability, and these result in turbulence in the air flow through the diffuser.

Especially in regard to water of condensation buildup and refrigerating capacity, the refrigerant lines are often laid with complex piping inside the diffuser housing, which likewise leads to increased pressure losses and thus lower efficiency and higher noise levels of the air conditioner. In addition, these indentations must often be drawn along the housing wall down to the lowest point of the tooling in the direction of mold release for technical reasons of the mold release process, which means additional blocking of the flow path.

If, on the other hand, the interfaces for the fluid lines do not lie in the immediate vicinity of the heat exchanger ports, complex and costly laying of the lines with long pipes, a number of bending points, additional supports and flanges is often necessary. These designs lead to both higher costs of parts and installation and greater weight, which stands in contradiction to the demand for a light and economical air conditioner, which at the same time is expected to provide a large overall volume of air with a low noise level in the passenger compartment.

Further problems result from the arrangements of the components beneath the dashboard with due provision for vehicle outfitting as right or left-hand drive model. For cost reasons and specifications of the other vehicle architecture, the interfaces for the ports of the automotive air conditioning system should usually remain in exactly the same position for left and right-hand drive model vehicles.

Likewise, the heat exchangers and evaporators with attached pipes should be the same for left and right-hand drive models, in order to provide an economical air conditioner. The route of the pipes to the heat exchangers and the diffuser geometry are dictated by the remaining installation space in the left-hand drive model, while the pipe route for connection of the evaporator results from the remaining installation space for the right-hand drive model.

For the left-hand drive model, the connecting of the heating heat exchanger and the fastening of the pipes requires large indentations in the housing wall of the diffuser near the evaporator. However, similar problems also result from the expansion valve in the right-hand drive model. In the right-hand drive model, the installation space problem is even further aggravated, because the outer part of the air distribution housing is not step or wedge shaped, as seen from above, near the evaporator inlet and therefore even less space is available for the positioning of the pipes. This is shown by the representation of the prior art according to FIG. 1.

### SUMMARY OF THE INVENTION

The solution to the problem is to create a light, compact and economical automotive air conditioning system. As compared to the prior art, the invention should ensure that an efficient air conditioner with comparable manufacturing, power and space requirements provides a higher volume of air to the passenger compartment at a lower noise level.

According to an embodiment of the invention, the problem is solved by a transitional air ducting element of an automotive air conditioner, in which there is arranged a feedthrough for the lines, the feedthrough being a flow ducting element that divides the air flow through the transition element into at least two flow pathways.

According to an embodiment of the present invention, the transition element is configured as a diffuser. It is advantageous to arrange the diffuser, a heat exchanger and/or a filter and a connector in succession, the feedthrough being configured in the connector. The feedthrough through the diffuser is configured perpendicular to the direction of flow of the air stream.

An embodiment of the invention consists in that fluid lines of the automotive air conditioner are arranged in the feedthrough through the diffuser. The fluid lines are refrigerant lines, coolant lines, or even electrical lines as well as ventilation lines, for example. The fluid lines hinder the gas flow inside the diffuser to a much lesser extent when they are led through this feedthrough as compared to when the lines are laid in deep indentations in the diffuser wall or the diffuser housing.

By optimization measures in the configuration of an at least a two-piece diffuser housing, it has been possible in one embodiment of the invention to arrange the feedthrough in a parting plane of a housing joint of the diffuser, and the lines can be installed in the feedthrough of the diffuser during the assembly process. The housing joint is the line of separation through the housing, which is composed of several parts. A housing joint can lie entirely in one plane, which is then called the parting plane, in a non-limiting example.

An embodiment of the invention involves the configuring of an installation cover, which is configured as a housing part of the diffuser and which contains a part of the feedthrough. The housing cover can be removed from the diffuser housing when installing the lines in the feedthrough during the assembly process.

It is advantageous for the feedthrough of the lines to be configured such that the latter are clamped with exact fitting in the feedthrough after the assembly process. This saves on additional parts needed for the fixation of the lines, which are generally configured as plastic parts.

Thus, the dual function of the diffuser feedthrough accomplishes both a reduced installation space and the possibility of saving on fixation points for the lines, such as the evaporator pipes, on the housing of the air conditioner itself, since the pipes when properly designed and allowing for all relevant tolerances are clamped more or less by means of the main housing halves.

Especially advantageous is a configuration in which several feedthroughs are arranged in the diffuser. In this way, several flow pathways can be created and furthermore, heating and cooling fluid lines of different temperatures can be laid in different feedthroughs.

One special benefit of the invented solution is that the center points of the connection openings for the fan and the air distribution housing are set off from the longitudinal axis of the air distribution housing and thus optimized in their arrangement. In this way, the velocity distribution downstream from the feedthrough remains uniform and fewer unpleasant noises and vibrations are produced.

According to an embodiment of the invention, the center points of the connection openings for the fan and the air distribution housing are arranged on the longitudinal axis of the air distribution housing.

By means of Computational Fluid Dynamics (CFD), the velocity distribution of the air flowing in the air distribution housing was calculated for a diffuser with one or two feedthroughs in a typical application and compared to that of the standard version. The calculated air mass flow remains almost the same for both proposed diffuser geometries with feedthroughs and the velocity distribution in the middle of the evaporator outlet surface is even somewhat more uniform, because the increased number of diffusers effectively reduces the aperture angle and thereby accomplishes a better rectifying effect. This meets the demand for the most uniform possible velocity distribution over the evaporator outlet surface, so that a maximum cooling power and a balanced distribution of air quantities at the outlets of the air conditioner are achieved, especially for multizone air conditioners. The desired interface positions with the fluid lines of the heat exchanger and the evaporator are thus achieved by the new housing geometry, especially in the region of the diffuser, without deep indentations in the housing wall of the air conditioner.

The diffuser is provided with at least one feedthrough, through which the fluid lines are led. In this way, one achieves a light air conditioner, which has a lower noise level with a reduced system pressure loss for high overall air volume and lower costs for components and installation. Specifically, for a given length a diffuser works more effectively as its local aperture angle is smaller, because this can reduce or prevent possible flow detachments more effectively. Furthermore, the invention meets the demand for the most uniform possible velocity distribution across the connection openings for the air distribution housing, so that maximum refrigerating power and balanced distribution of air volumes at the outlets of the air conditioner are achieved.

Finally, since the feedthrough of the heat exchanger pipes in the diffuser is preferably centered to its parting line and the pipes are led through the intermediate space that is produced by the parting of the diffuser, there are savings for fixation points on the heat exchanger pipes.

The concept of the invention consists in leading the lines, especially the fluid supply lines for the heat exchanger of the air conditioner, to the required positions such that no additional installation space is required for the connection lines and no deep indentations, which have adverse influences on the air flow on the inside and therefore cause greater pressure loss, are needed in the housing wall of the air conditioner.

### BRIEF DESCRIPTION OF THE DRAWINGS

Further details, features and benefits of embodiments of the invention will emerge from the following description of sample embodiments with reference to the accompanying drawings. There are shown:

FIG. 1 illustrates a pipe routing for an automotive air conditioner according to prior art;

FIG. 2 illustrates a schematic of a housing geometry of a diffuser with a feedthrough for fluid lines;

FIGS. 3a-3c illustrate an aperture angle of a diffuser according to three embodiments of the invention;

FIGS. 4a-4f illustrate housing joints of a diffuser according to six embodiments of the invention;

FIG. 5 illustrates a schematic of a housing geometry of a diffuser with the air distribution housing, upstream filter, heat exchanger, and connector according to another embodiment of the invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

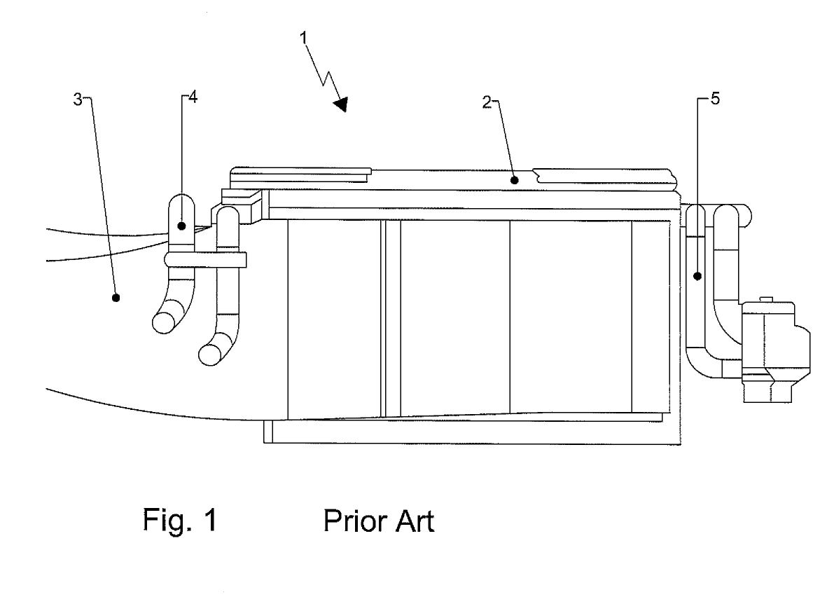

FIG. 1 shows schematically an automotive air conditioner 1 consisting of an air distribution housing 2 and a transitional air ducting element, or a diffuser, 3 with classical pipe routing of heat exchanger pipes 4 and evaporator pipes 5 with a connected expansion valve at the desired interface positions according to automobile air conditioners known in the art. One distinctly recognizes in the version shown in FIG. 1 that the fluid lines for both heat exchangers are laid entirely outside the housing and consequently require extra installation space.

According to other automobile air conditioners known in the art, not shown here, the pipes 4, 5 are set in deep indentations of the housing, so that no additional installation space is required on the outside. However, this has the drawback that the indentations greatly obstruct the air flow inside the air conditioner and thus ultimately bring about losses in performance of the appliance.

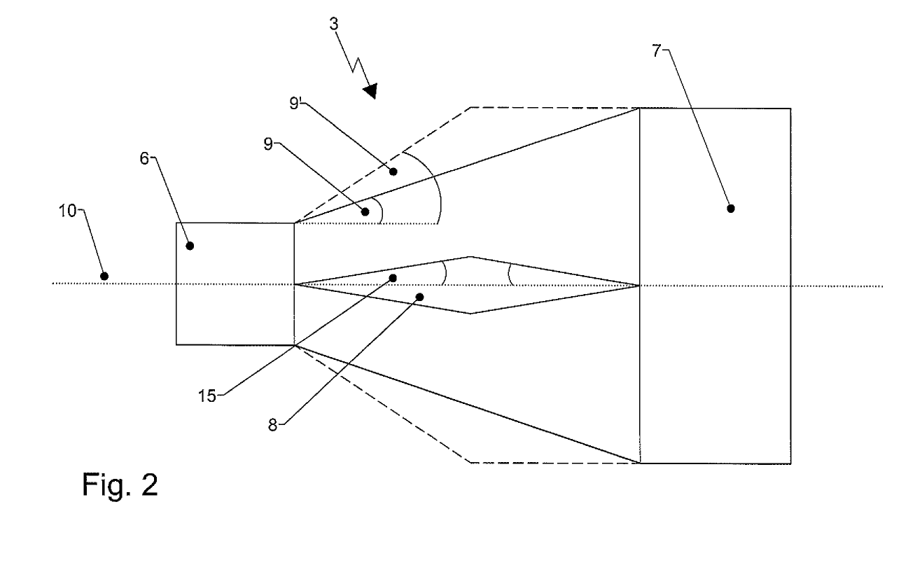

FIG. 2 shows in a schematic representation a longitudinal section through a symmetrical, nearly two-dimensional diffuser 3, where the solid black lines show a diffuser 3 with an aperture angle 9 of 20° relative to the center line 10, for example. The angle 9 results from the difference in heights of the connection opening 6 for the fan 11 and a connection opening 7 for the air distribution housing 2 relative to their spacing from each other.

Now, if the rhomboidal region with an aperture angle 15 of 10° relative to the center line 10, for example, is realized as a feedthrough 8 across the housing wall of the diffuser 3, there results in principle two diffusers 3 one above the other, whose local aperture angle becomes much smaller than 20°. The term local aperture angle designates the difference between the aperture angle 9 of the diffuser 3 and the aperture angle 15 of the feedthrough 8, both of them relative to the center line 10.

If the cross section losses caused by the rhomboidal feedthrough 8 are counterbalanced by widening of the aperture angle 9′ to 25°, for example, as shown by the broken lines of FIG. 2, one gets a local aperture angle of 15° relative to the center line 10.

The transition from this two-dimensional schematic representation to a realistic three-dimensional diffuser 3 is easy, for as a rule, the connection 6 for the fan 11 has a rectangular shape and the connection 7 for the air distribution housing 2 almost always has a rectangular cross section in the direction of the air distribution housing. Since generally two deformable plastic parts are provided for this region, one usually gets a nearly two-dimensional shape in terms of the direction of widening of the diffuser. For space considerations, widening in the third dimension usually cannot be accomplished, and round shapes are not customary for the connections of automotive air conditioners.

It is known that a diffuser 3, for a given length, works more effectively if one can realize a loss-free lowering of the flow velocity and hence a pressure rise along the diffuser length according to the Bernoulli equation. A smaller local aperture angle means less widening of the cross section, so that intense pressure rises associated with possible flow detachments can be effectively prevented.

This means that the efficiency of the diffuser 3 in terms of a low pressure loss can be kept constant or at best even increased by avoidance of detachments, even though a feedthrough 8 has been created for the lines in the diffuser 3. Depending on the available installation space in the region of the diffuser 3, one can also realize more than one feedthrough 8 in the diffuser 3 to further reduce the local aperture angle.

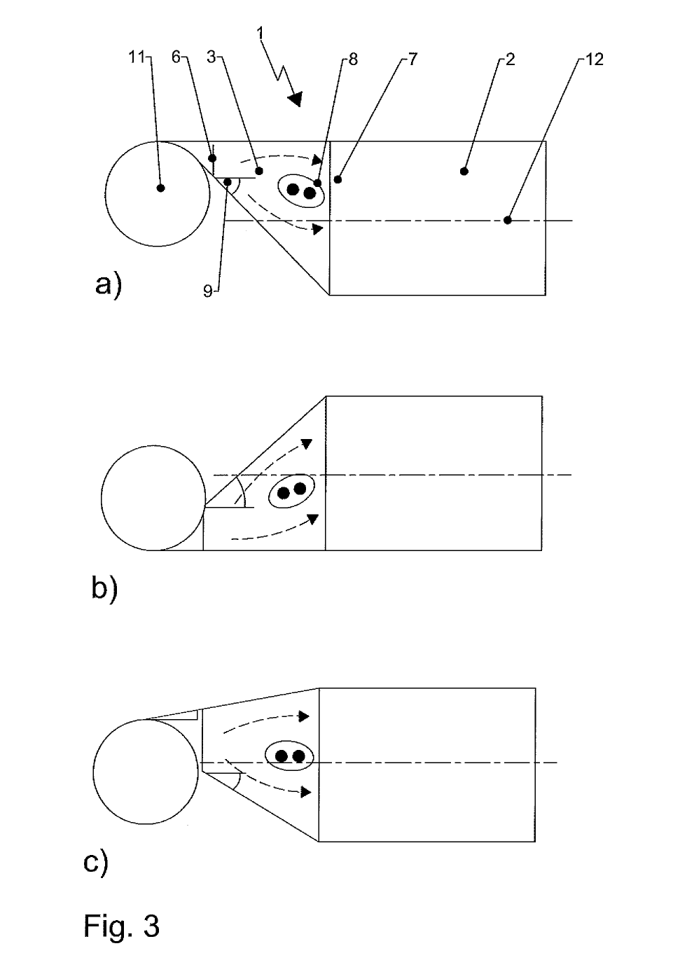

FIGS. 3a, 3b and 3c schematically show automotive air conditioners 1 with different diffusers 3, each one having a feedthrough 8. The geometries, for space considerations, result from the fact that the fan 11 is displaced upward or downward relative to the air distribution housing 2 or arranged in the middle. With a greatly off-center position of the connection opening 6 of the fan 11 as in FIG. 3a or 3b, a very large aperture angle 9 results for one side of the diffuser 3, which often leads to intense flow detachments with increased noise level.

A more suitable arrangement of the connection opening 6 for the fan 11 per FIG. 3c is characterized in that the center points of the connection opening 6 for the fan 11 and the connection opening 7 for the air distribution housing 2 are displaced relative to the longitudinal axis 12 of the air distribution housing 2. Another arrangement (not shown) results when the center points of the connection opening 6 for the fan 11 and the connection opening 7 for the air distribution housing 2 are located directly on the longitudinal axis 12 of the air distribution housing 2.

Along with an appropriate configuration of the feedthrough 8, this leads to a reduction in the local aperture angle, which accomplishes at least the same pressure decrease as in the diffuser 3 version without feedthrough 8. The free flow cross section of the connection opening 6 for the fan 11 is the same as the diffuser 3 inlet area and the free flow cross section of the connection opening 7 for the air distribution housing 2 is at the same as the diffuser 3 outlet area.

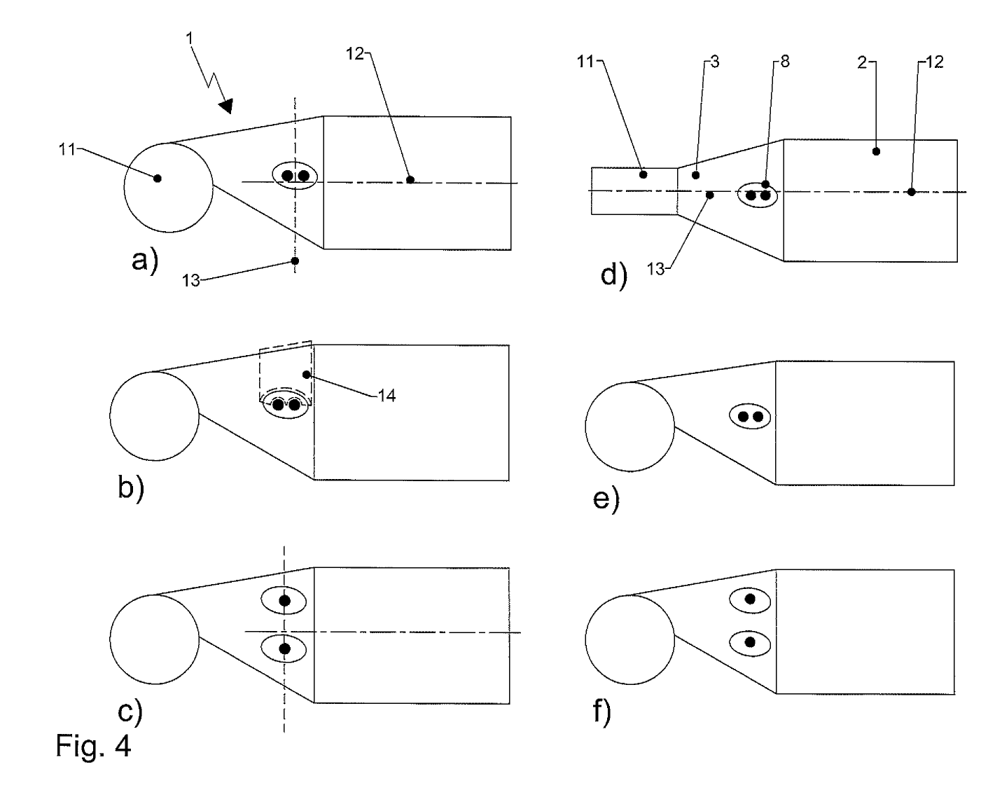

FIGS. 4a, 4b, 4c, 4d, 4e and 4f show schematically different housing divisions for the diffusers 3 of the automotive air conditioner 1, most of them configured as parting planes 13. Depending on the orientation of the fan 11, or the fan spiral, relative to the air distribution housing 2 and the number of feedthroughs 8 through the diffuser 3, several variants can be configured advantageously and they are included in the notion of the invention.

For air conditioners with side mountings per FIGS. 4a and 4c, it is often required that the air inlet with the fan 11 and the diffuser 3 can be dismounted separately from the air distribution housing 2 in event of servicing work. In this case, it is advantageous to arrange the parting plane 13 through the diffuser 3 perpendicular to the longitudinal axis 12 of the air distribution housing 2 and the feedthrough 8 relatively central in the parting plane 13 between right and left parts.

FIG. 4b likewise shows a multipart variant embodiment, wherein the additional part is reduced in its dimensions to an installation cover 14. The installation cover 14 is designed independently of the housing division of the diffuser 3. In this variant, the installation cover 14 is configured as part of the feedthrough 8 and at the same time as part of the diffuser 3. Thus, during installation, the lines being laid are not pushed through, but instead can be inserted from above into the feedthrough 8 of the diffuser 3, for example. The feedthrough 8 and the remaining opening of the diffuser 3 are then closed with the installation cover 14 and the pipes are clamped at the same time during the installation.

FIGS. 4d, 4e, and 4f have a parting plane 13, shown in FIG. 4d, along the plane of symmetry of the fan 11. The feedthrough 8 here can be arranged either parallel to the parting plane 13 per FIG. 4d or perpendicular to the parting plane 13 per FIGS. 4e and 4f, the variants per FIGS. 4e and 4f being characterized in that the pipes are pushed through the feedthrough 8.

For the division of a diffuser 3 with two feedthroughs 8, there are two possible variants. In one variant, the division occurs by a configuration in FIG. 4c perpendicular to the direction of flow into a right and a left part. Alternatively, the division occurs in the direction of the longitudinal axis 12 of the air distribution housing 2 and perpendicular to the feedthroughs 8. In this configuration, however, the lines must be laid by pushing through the feedthroughs 8.

All variants have in common that the number of housing parts remains the same compared to the classical arrangement and no additional housing parts are needed.

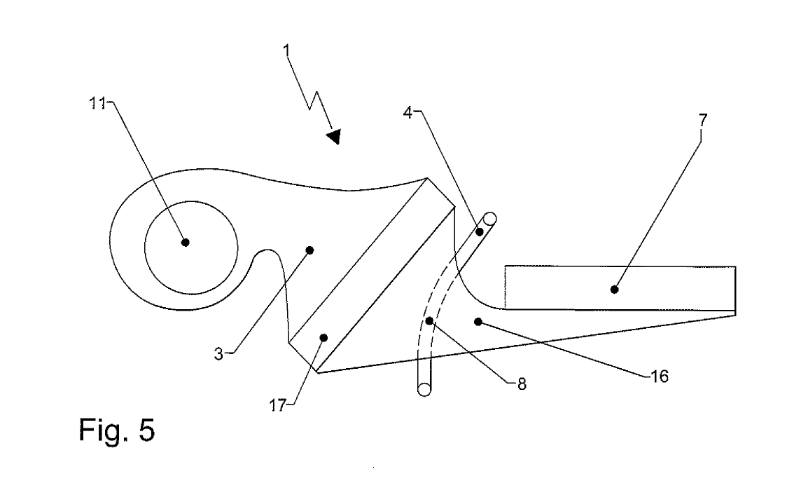

FIG. 5 shows another embodiment of the invention, whereby instead of a simple diffuser 3 between the fan 11 and the air distribution housing 2 there is arranged a combination of a diffuser 3, a filter 17 and a connector 16, wherein the feedthrough 8 leads through the connector 16. It is especially advantageous to place, at the position of the filter 17, an evaporator, a heat exchanger, or a combination of the filter 17, the evaporator and the heat exchanger. The air distribution housing 2 then no longer contains those components that are now located at the position of the filter 17.

The adjacent air ducting connector 16 collects the air leaving the filter 17 once again and diverts it in the direction of the air distribution housing 2. Strictly speaking, the connector 16 no longer functions as the diffuser, yet it is still possible to push the heat exchanger pipes 4 or the evaporator pipes 5 through the feedthrough 8 provided in the housing, especially in regard to the left-hand and right-hand drive models.

From the foregoing description, one ordinarily skilled in the art can easily ascertain the essential characteristics of this invention and, without departing from the spirit and scope thereof, can make various changes and modifications to the invention to adapt it to various usages and conditions.

### LIST OF REFERENCES

1. automotive air conditioner

2. air distribution housing

3. diffuser, transitional air ducting element

4. heat exchanger pipes

5. evaporator pipes

6. connection opening for the fan

7. connection opening for the air distribution housing

8. feedthrough

9. 9′. aperture angle of the diffuser

10. center line of the diffuser

11. fan

12. longitudinal axis of the air distribution housing

13. parting plane

14. installation cover

15. aperture angle of the feedthrough

16. connector

17. filter

What is claimed is:

1. An automotive air conditioner comprising:
an air distribution housing; and
a transitional air ducting element in fluid communication with the air distribution housing and conveying a flow of air, the transitional air ducting element having at least one feedthrough formed therein, the at least one feedthrough configured to house at least one pipe associated with the air conditioner and divide the flow of air within the transitional air ducting element.

2. The automotive air conditioner of claim 1, wherein the transitional air ducting element is a diffuser.

3. The automotive air conditioner of claim 2, wherein the at least one feedthrough is formed in the diffuser perpendicular to a direction of the flow of air within the transitional air ducting element.

4. The automotive air conditioner of claim 2, wherein the at least one feedthrough has a cross-sectional shape of a rhombus and an aperture angle in respect of a center line of the diffuser, the at least one feedthrough configured to divide the flow of air within the transitional air ducting element into at least two streams.

5. The automotive air conditioner of claim 4, wherein the diffuser has a local aperture angle in respect of the center line of the diffuser, the local aperture angle equal to a difference between an aperture angle of the diffuser and the aperture angle of the at least one feedthrough.

6. The automotive air conditioner of claim 1, wherein the transitional air ducting element has a diffuser, at least one of a filter and a heat exchanger in fluid communication with the diffuser, and a connector in fluid communication with the at least one of the filter and the heat exchanger, wherein the at least one feedthrough is disposed in the connector.

7. The automotive air conditioner of claim 1, further comprising a fan in fluid communication with the transitional air ducting element, the transitional air ducting element intermediate the fan and the air distribution housing, the fan having a connection opening disposed at an inlet of the transitional air ducting element and the air distribution housing having a connection opening disposed adjacent an outlet of the transitional air ducting element,

8. The automotive air conditioner of claim 7, wherein a width of the connection opening of the fan and a width of the connection opening of the air distribution housing are substantially perpendicular to a longitudinal axis of the air distribution housing, and wherein at least a portion of the connection opening of the fan and at least a portion of the connection opening of the air distribution housing are disposed on the longitudinal axis of the air distribution housing.

9. The automotive air conditioner of claim 1, wherein the transitional air ducting element has a parting plane configured to divide the transitional air ducting element.

10. The automotive air conditioner of claim 8, wherein the parting plane is one of parallel to a longitudinal axis of the air distribution housing and perpendicular to a longitudinal axis of the air distribution housing.

11. The automotive air conditioner of claim 8, wherein the at least one feedthrough is disposed one of parallel to a longitudinal axis of the air distribution housing and perpendicular to a longitudinal axis of the air distribution housing.

12. The automotive air conditioner of claim 8, wherein at least a portion of the at least one feedthrough is disposed on the parting plane.

13. The automotive air conditioner of claim 1, further comprising an installation cover disposed on the transitional air ducting element, the installation cover forming at least a portion of the at least one feedthrough.

14. The automotive air conditioner of claim 1, wherein the transitional air ducting element includes a plurality of feedthroughs.

15. An automotive air conditioner comprising:
an air distribution housing;
a transitional air ducting element in fluid communication with the air distribution housing and conveying a flow of air, the transitional air ducting element having at least one feedthrough formed therein, the at least one feedthrough configured to house at least one of a heat exchanger pipe associated with the air conditioner and an evaporator pipe associated with the air conditioner and divide the flow of air within the transitional air ducting element; and
a parting plane configured to divide the transitional air ducting element.

16. The automotive air conditioner of claim 15, wherein the transitional air ducting element is a diffuser and the at least one feedthrough is formed in the diffuser perpendicular to a direction of the flow of air within the transitional air ducting element.

17. The automotive air conditioner of claim 15, further comprising a fan in fluid communication with the transitional air ducting clement, the transitional air ducting element intermediate the fan and the air distribution housing, the fan having a connection opening disposed at an inlet of the transitional air ducting element and the air distribution housing having a connection opening disposed adjacent an outlet of the transitional air ducting element, wherein a width of the connection opening of the fan and a width of the connection opening of the air distribution housing are substantially perpendicular to a longitudinal axis of the air distribution housing, and wherein at least a portion of the connection opening of the fan and at least a portion of the connection opening of the air distribution housing are disposed on the longitudinal axis of the air distribution housing.

18. The automotive air conditioner of claim 15, wherein the parting plane is one of parallel to a longitudinal axis of the air distribution housing and perpendicular to the longitudinal axis of the air distribution housing and the at least one feedthrough is disposed one of parallel to the longitudinal axis of the air distribution housing and perpendicular to the longitudinal axis of the air distribution housing.

19. An automotive air conditioner comprising:
an air distribution housing;
a transitional air ducting element in fluid communication with the air distribution housing and conveying a flow of air, the transitional air ducting element having at least one feedthrough formed therein perpendicular to a direction of the flow of air within the transitional air ducting element, the at least one feedthrough configured to house at least one of a heat exchanger pipe associated with the air conditioner and an evaporator pipe associated with the air conditioner and divide the flow of air within the transitional air ducting element; and
a parting plane configured to divide the transitional air ducting element, the parting plane is one of parallel to a longitudinal axis of the air distribution housing and perpendicular to the longitudinal axis of the air distribution housing, wherein at least a portion of the at least one feedthrough is disposed on the parting plane.

20. The automotive air conditioner of claim 19, further comprising a fan in fluid communication with the transitional air ducting element, the transitional air ducting element intermediate the fan and the air distribution housing, the fan having a connection opening disposed at an inlet of the transitional air ducting element and the air distribution housing having a connection opening disposed adjacent an outlet of the transitional air ducting element, wherein a width of the connection opening of the fan and a width of the connection opening of the air distribution housing are perpendicular to the longitudinal axis of the air distribution housing, and wherein at least a portion of the connection opening of the fan and at least a portion of the connection opening of the air distribution housing are disposed on the longitudinal axis of the air distribution housing.
